(19) United States
(12) Patent Application Publication
(10) Pub. No.: US 2025/0271033 A1
(43) Pub. Date: Aug. 28, 2025

(54) BEARING COMPONENT HAVING A COATING

(71) Applicant: AKTIEBOLAGET SKF, GOTEBORG (SE)

(72) Inventors: Christoph BLEICHER, Steyr (AT); Karl PREIS, Traun (AT); Stefan STROBL, Garsten (AT)

(21) Appl. No.: 19/053,603

(22) Filed: Feb. 14, 2025

(30) Foreign Application Priority Data
Feb. 28, 2024 (DE) 102024201850.3

(51) Int. Cl. F16C 33/62

(52) U.S. Cl. CPC F16C 33/62

(57) ABSTRACT

A bearing component includes a main bearing component body, such as a bearing ring, and a coating on the main bearing component body, where the coating includes at least one material curable with electromagnetic radiation in a cured or uncured state. Also a method of applying a coating to a bearing component.

### CROSS-REFERENCE

This application claims priority to German patent application no. 10 2024 201 850.3 filed on Feb. 28, 2024, the contents of which are fully incorporated herein by reference.

### TECHNOLOGICAL FIELD

The present disclosure is directed to a bearing component, especially a bearing ring, having a coating, and to a method of applying the coating.

### BACKGROUND

Electrically insulated bearings that are used in electric motors, for example, often have an electrically insulating coating on their main metal bodies, for example composed of a ceramic material or a polymer material or a composite material.

Such insulating layers may be applied to the main body, for example, by plasma spraying or by injection molding, especially in the case of use of plastic, for example PPS. However, because of the porous character of such coatings, these have to be impregnated and cured for several hours. The aim is to obtain a completely impervious, watertight, impregnated and hence insulating coating. Although plasma spraying is a very well known technique, process control is not easy, and many problems can occur, for example inclusions of tungsten or an inhomogeneous porosity distribution in the coating. Moreover, the desired electrical properties have to be adjusted by the choice of additives in a moist environment etc. Furthermore, especially in the case of PPS coatings, a corresponding injection mold is needed in the injection molding process, which has to be specially produced for each type of bearing. In the case of large bearings, the size of the bearing additionally means that the method is usable only with great difficulty, if at all.

### SUMMARY

It is therefore an aspect of the present disclosure to provide a bearing coating which can be more easily and quickly applied to the bearing component.

There follows a discussion of a bearing component, especially a bearing ring, for a rolling bearing, slide bearing and/or linear bearing, having a main bearing component body and a coating applied to the main bearing component body. The main bearing component body is preferably made of metal, in particular of a bearing steel. In order to accelerate the coating process and to make it less expensive, it is additionally disclosed that a coating including at least one material curable by electromagnetic radiation, preferably photonically, be applied to the bearing component.

Since the speed of thermal curing processes rises exponentially with temperature—i.e. following the Arrhenius law—coatings curable by electromagnetic radiation, preferably photonically, can be cured much more quickly than conventional coatings that have to be dried or sintered. This can achieve a significant shortening of processing time with a simultaneous increase in productivity and reduction of energy demand. For example, it is possible to reduce the total production time (for coating with subsequent curing) from several hours to less than 25 min per bearing. Since there is no need to use a furnace for the thermal curing, it is additionally possible to improve the CO₂ balance. Furthermore, in the course of curing, it can be ensured by means of electromagnetic radiation that there is only slight heating of the main body, if any, such that the physical and chemical properties, especially the constancy of mass and microstructure, of the main body are maintained.

In addition, the coating of the material curable by electromagnetic radiation can be applied to bearing components of any size and shape without having to produce special coating tools or molds.

In a further preferred working example, the material curable by electromagnetic radiation is electrically conductive or electrically insulating or a semiconductor material. It is possible in this way to create tailored electrical and/or mechanical properties. For example, the material properties may be chosen such that the bearing component has particularly good damping, a low noise/vibration level and/or tailored electrical conduction and/or functional performance, for example insulation or locally limited high conductivity or sensor capacity.

For this purpose, the coating may also include different materials curable by electromagnetic radiation. Alternatively or additionally, the coating may also include multiple layers of the same or different materials curable by electromagnetic radiation. In this way, it is possible to enable modification to different material compositions, and advantageous mechanical properties are achievable. In addition, this also makes it possible to implement, for example, sensors directly in the layers, for example by accordingly selecting the corresponding materials. For example, it is possible by means of copper ink, silver or gold to form current pathways on the bearing component and to fix them by means of curing by electromagnetic radiation.

In a further advantageous working example, one or more sensors or electrical or electronic devices or functional ceramic elements, for example a piezo crystal or generally a piezoelectric material, may be embedded in the coating. For example, strain gauges, temperature sensors, capacitance measuring elements, crack sensors, stress measuring elements and/or other ceramic-metal functional components, semiconductor components or heat-dissipating elements may be embedded into the coating. This is possible in particular because the curing by electromagnetic radiation does not cause any damage in the sensitive sensors, as could occur, for example, in the case of heating and curing in a furnace for a period of hours. Furthermore, preparatory elements, for example for live monitoring of the bearing, may also be embedded in the coating.

In a further working example, the material curable by electromagnetic radiation has a matrix curable by electromagnetic radiation, especially a polymer matrix, into which one or more fillers are embedded, where the fillers preferably include ceramic, metal, polymer, metal oxide and/or non-metal oxide, and/or organic substances, for example a resin curable by UV light.

It is alternatively or additionally also possible to embed the abovementioned embeddable sensors or electrical components into this matrix.

In a further preferred working example, the material curable by electromagnetic radiation comprises Al₂O₃, ZrO₂, ZnO, Ti₂O, Cu, Ag, Au and/or functional inks, and/or perovskites, such as BaTiO₃, Pb(ZrₓTi₁₋ₓ)O₃ with x<0.94, LiNbO₃, SrTiO₃, KNbO₃, NaNO₂.

The coating may be formed on the raceways or sliding surfaces of the bearing component, but it is particularly preferable to form the coating on the so-called non-functional bearing surfaces that are not subject to any rolling or sliding contact, since it is possible in the case of these in particular, with the aid of the coating, to implement other mechanical and/or electrical and/or sensory properties that are important for the bearing component.

A further aspect of the present disclosure relates to a method of applying a coating to a bearing component, having the following steps: applying a coating material curable by electromagnetic radiation in a thermodynamically stable state to a main bearing component body in order to obtain a coating in the green state on the main bearing component body; irradiating the bearing component with the coating applied in the green state with electromagnetic radiation; and solidifying the coating by the curing process induced by the electromagnetic radiation.

The coating can be applied here as a slurry, liquid solution, aerosol, resin, or another suitable mixture of the coating material in any state of matter to the bearing component, for example an inner bearing surface and/or outer ring surface or interface.

In particular, the coating material is applied by means of a metering unit, for example a spray gun, or rotary coating by a dipping method or 3D printing or other additive methods, for example screen printing, inkjet printing, lithography etc. In this way, the coating can be applied easily and quickly to bearing components of any size and shape.

The bearing component with the coating in the green body state can then be positioned in a system in which it is held such that the coating is accessible. Furthermore, it can be rotated within the system and optionally cooled, in order to rule out all thermal influences in the curing by electromagnetic radiation on the main bearing body.

Subsequently, the coating is solidified by a curing process, wherein the component is irradiated with electromagnetic radiation. The bearing component can be irradiated here by means of an electromagnetic radiation source, preferably by means of a pulsed light source, especially an Xe flashlamp. The electromagnetic irradiation can be effected sequentially, i.e. the bearing component may be scanned with the light source, but it is also possible to introduce the bearing component into an irradiation apparatus. In addition, the mode of action of the radiation source may be amplified by a radiation conduction and isolation apparatus, for example a photon conduction and isolation apparatus. For this purpose, it is possible in particular to use a mirror, especially a cooled mirror.

Further advantages and advantageous embodiments are specified in the description, the drawings and the claims. In particular the combinations of the features specified in the description and in the drawings are purely illustrative here, and therefore the features can also be present individually or in other combinations.

### BRIEF DESCRIPTION OF THE DRAWINGS

Aspects of the disclosure will be described in detail hereinafter with reference to working examples shown in the drawings. The working examples and the combinations shown in the working examples are purely illustrative and are not intended to restrict the scope of protection of the invention. The latter is defined solely by the appended claims.

FIGS. 1A and 1B are schematic diagrams of a bearing component in various stages of coating.

FIG. 2 is a schematic diagram of an irradiation apparatus.

FIG. 3 is a schematic diagram of a bearing component in which a coating is formed in multiple layers.

### DETAILED DESCRIPTION

Identical or functionally identical elements are identified by the same reference numerals hereinafter.

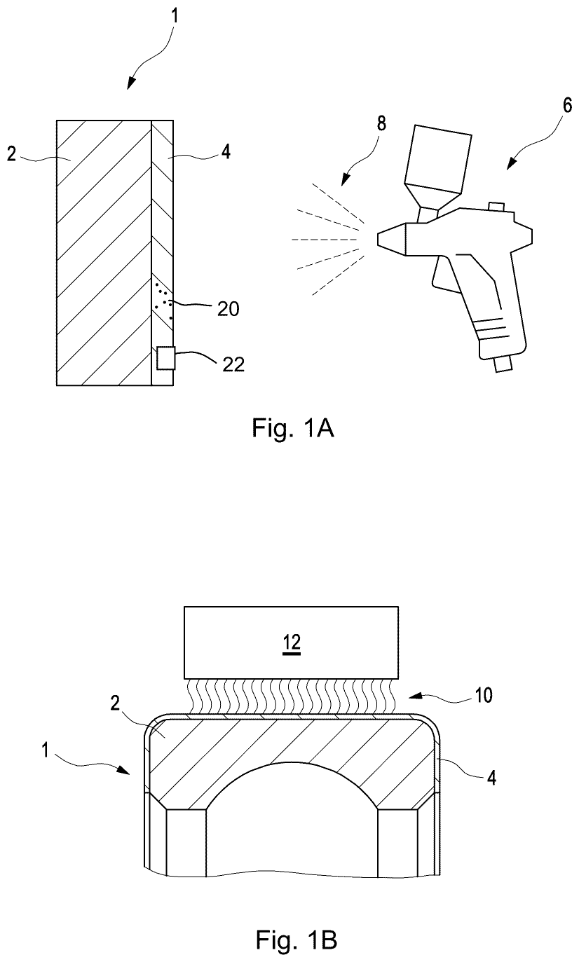

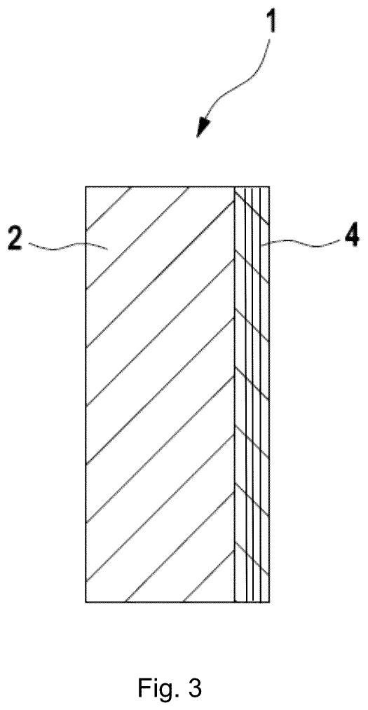

FIG. 1A shows a portion of a bearing component 1 having a main body 2 and a coating 4, wherein the coating 4 is applied at the stage shown and in the working example shown with the aid of a spray gun 6. In this working example, the coating material 8 is in the fluid state during coating with the spray gun. The main bearing body 2 has been manufactured from a metal, especially a bearing steel. The coating 4, or the coating material which is applied to the bearing component 1 or the main bearing component body 2, includes at least one material curable by electromagnetic radiation, especially photonically, and indicated schematically in FIG. 1B. As shown in FIG. 3, the coating may be applied in layers-either as multiple layers of a same material or as layers of two or more different materials.

The main body 2 may be a bearing ring that has a raceway portion 24 and a non-raceway portion 26. The coating 4 is preferably applied to the non-raceway portion 24.

The material curable by electromagnetic radiation may, for example, have a matrix curable by electromagnetic radiation, especially a polymer matrix, into which one or more fillers 20 are embedded, where the fillers preferably include ceramic, metal, polymer, metal oxide and/or non-metal oxide. In particular, the material curable by electromagnetic radiation may include Al₂O₃, ZrO₂, ZnO, Ti₂O, Cu, Ag, Au and/or functional inks, and/or perovskites.

As suggested by FIG. 1B, the coating material curable by electromagnetic radiation is then irradiated with electromagnetic radiation 10 in order to cure the coating 4. It is possible here for the electromagnetic radiation 10 to be provided, for example, by a radiation source 12, especially a pulsed radiation source 12. In particular, an Xe flashlamp is used here.

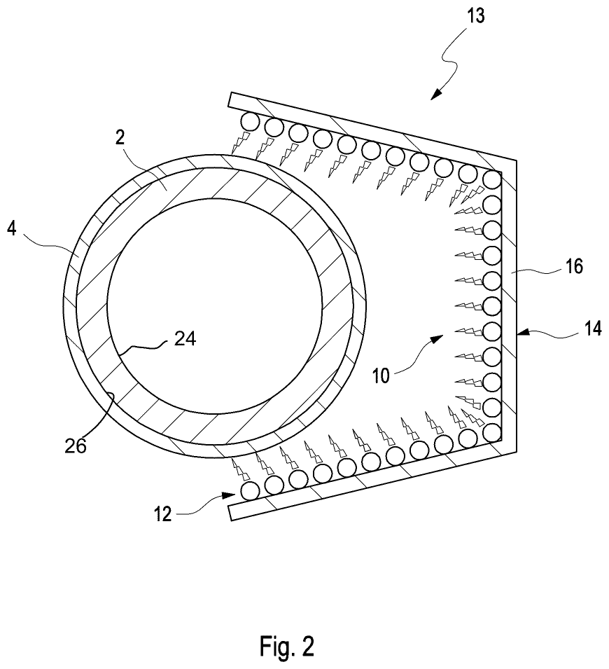

The coating 4 is solidified by the irradiation via the curing process which is induced by electromagnetic radiation. The irradiation can be effected sequentially, i.e. the bearing component 2 may be scanned with the radiation source 12, but it is also possible to introduce the bearing component 2, as shown in FIG. 2, into an irradiation apparatus 13. It is possible here to mount several radiation sources 12 on a carrier 14. In addition, the mode of action of the radiation sources 12 may be amplified by the use of a radiation conduction and isolation device. For this purpose, for example, the carrier 14 may take the form of a mirror 16, especially a cooled mirror 16, which supports multiple radiation sources 12.

Since the speed of thermal curing processes rises exponentially with temperature—i.e. following Arrhenius' law—the photonically curable coating 4 can be cured much more quickly than conventional coatings that have to be dried or sintered. This can achieve a significant shortening of processing time with a simultaneous increase in productivity and reduction of energy demand. For example, it is possible to reduce the total production time (for coating with subsequent curing) from several hours to less than 25 min per bearing. Since there is no need to use a furnace for the thermal curing, it is additionally possible to improve the CO₂ balance. Furthermore, in the course of curing, it can be ensured by means of electromagnetic radiation that there is only slight heating of the main body 2, if any, such that the chemical and physical properties, especially the constancy of mass and microstructure, of the main body 2 are maintained.

The material curable by electromagnetic radiation may be electrically conductive or electrically insulating or a semiconductor material. It is possible in this way to create tailored electrical and/or mechanical properties. For example, the material properties may be chosen such that the bearing component has particularly good damping, a low noise/vibration level and/or tailored electrical conduction and/or functional performance, for example insulation or locally limited high conductivity or sensor capacity.

In addition, the coating 4 may also include multiple different materials curable by electromagnetic radiation. The coating 4 also may include one or more objects 22, such as sensors and/or electronic components embedded therein. For example, the objects may be strain gauges, temperature sensors, capacitance measuring elements, crack sensors, stress measuring elements and/or other ceramic-metal functional components, semiconductor components or heat-dissipating elements.

Overall, by virtue of the coating composed of a material curable by electromagnetic radiation, it is possible to produce a bearing component that can be manufactured much more quickly than with conventional coatings. Furthermore, it is possible by virtue of the coating to implement tailored electrical and/or mechanical properties.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved coated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### List of Reference Signs

1 bearing component
2 main bearing component body
4 coating
6 spray gun
8 coating material
10 electromagnetic radiation
12 radiation source
13 coating apparatus
14 carrier
16 mirror
20 fillers
22 object
24 raceway
26 non-raceway

What is claimed is:

1. A bearing component comprising:
a main bearing component body, and
a coating on the main bearing component body,
wherein the coating includes at least one material curable with electromagnetic radiation in a cured or uncured state.

2. The bearing component according to claim 1,
wherein the bearing component is a bearing ring.

3. The bearing component according to claim 2,
wherein the at least one material curable by electromagnetic radiation is an electrically conductive material or an electrically insulating material or a semiconductor material.

4. The bearing component according to claim 2,
wherein the at least one material curable with electromagnetic radiation comprises a first material curable with electromagnetic radiation and a second material curable with electromagnetic radiation, the second material being different than the first material.

5. The bearing component according to claim 2,
wherein the coating includes two or more layers of a same material curable by electromagnetic radiation or two or more layers of different materials curable by electromagnetic radiation.

6. The bearing component according to claim 2,
wherein the at least one material curable with electromagnetic radiation includes a matrix curable by the electromagnetic radiation and at least one filler embedded in the matrix.

7. The bearing component according to claim 2,
wherein the matrix comprises a polymer matrix, and
wherein the at least one filler is selected from the group consisting of ceramic, metal, polymer, metal oxide, non-metal oxide and organic substances.

8. The bearing component according to claim 2, including at least one object embedded in the coating,
wherein the at least one object is selected from the group consisting of sensors, electrical devices, electronic devices and functional ceramic elements.

9. The bearing component according to claim 2,
wherein the at least one material curable by electromagnetic radiation is selected from the group consisting of: Al₂O₃, ZrO₂, ZnO, Ti₂O, Cu, Ag, Au, functional inks and perovskites.

10. The bearing component according to claim 2,
wherein the bearing ring includes a raceway portion and a non-raceway portion, and
wherein the coating is applied to the non-raceway portion.

11. The bearing component according to claim 2,
wherein the at least one material curable with electromagnetic radiation is in the cured state.

12. The bearing component according to claim 2,
wherein the at least one material curable with electromagnetic radiation is in the uncured state.

13. A method of applying a coating to a bearing component comprising:
applying an uncured coating of a material curable by electromagnetic radiation to the bearing component, and
irradiating the uncured coating with electromagnetic radiation to convert the uncured coating into a cured coating.

14. The method according to claim 13,
wherein the bearing component comprises a bearing ring.

15. A method according to claim 14,
wherein the applying comprises applying by a metering apparatus, applying by a spray bun, applying by dipping or applying by an additive method.

16. The method according to claim 15,
wherein the irradiating comprises irradiating using a pulsed radiation source.

17. The method according to claim 16,
including amplifying the electromagnetic radiation using a radiation conduction and isolation apparatus during the irradiating.
